(19) United States
(12) Patent Application Publication
(10) Pub. No.: US 2026/0138431 A1
(43) Pub. Date: May 21, 2026

(54) IN-CHASSIS BATTERY FOR ELECTRICALLY DRIVEN VEHICLE

(71) Applicant: Lumina Technology Inc., Lewes, DE (US)

(72) Inventors: Glenn Alun Andrew Melford-Colegate, Wellington (GB); Ahmed Shubber, Austin, TX (US)

(21) Appl. No.: 18/955,881

(22) Filed: Nov. 21, 2024

(51) Int. Cl. B60K 1/04; B60L 50/60; E02F 9/08; H01M 50/242; H01M 50/249

(52) U.S. Cl. CPC B60K 1/04; B60L 50/66; H01M 50/242; H01M 50/249; B60K 2001/0438; B60K 2001/0494; B60L 2200/40; E02F 9/0866; H01M 2220/20

(57) ABSTRACT

Embodiments are described providing efficient ways for housing batteries in electrically driven vehicles. In particular, a vehicle chassis is described comprising an internal cavity for holding one or more batteries. The batteries can be mounted within the chassis cavity and held on rails, allowing the batteries to extend out of the chassis cavity on the rails for servicing and removal/replacement. In various embodiments, the chassis cavity can be separated into sub-compartments by one or more partition walls running lengthwise along the chassis inside the cavity. Each sub-compartment can hold a separate battery similarly mounted on rails, allowing each battery to extend out of the chassis cavity individually.

### TECHNICAL FIELD

The present disclosure generally relates to electrically driven vehicles, and more particularly to systems and methods for housing batteries in electrically driven vehicles.

### BACKGROUND OF THE INVENTION

Electric vehicles offer numerous advantages over their traditional, internal combustion engine counterparts. For example, electric vehicles can exhibit superior performance, require less maintenance, and have lower operating costs, all while being less polluting to the environment.

Generally, the motor and drivetrain in electric vehicles tends to be more compact than in internal combustion engine vehicles, allowing for greater flexibility in design. However, the batteries required to power electric vehicles are typically large, heavy, require protection from impact, and need to be mounted in a way that allows for servicing, all of which has made battery integration one of the principal challenges in the design of electric vehicles. The difficulties are further compounded in the design of heavy-duty work electric vehicles such as electric bulldozers, tractors, etc., where battery size and weight are substantial, and the vehicles are subjected to extreme forces and hazardous conditions.

For example, a heavy-duty machine such as a bulldozer would require an extremely high-capacity battery to achieve sufficient run-time. Placing the battery high on the vehicle not only creates an obstruction but may also raise the center of gravity of the machine, having negative impacts on balance and performance. Further, because such a battery would generally be large and bulky, locating the battery in the vehicle without compromising the vehicle's structural integrity, while also providing sufficient protection from impact and access to the battery for servicing, presents a significant challenge.

What is needed is an efficient way for housing batteries in electrically driven vehicles.

### BRIEF DESCRIPTION OF DRAWINGS

FIG. 1 illustrates an example of an electrically driven vehicle, in accordance with various embodiments.

FIG. 2 illustrates an example cut away view of a chassis in an electrically driven vehicle, in accordance with various embodiments.

FIG. 3 illustrates a sectional view of the chassis as viewed from a line A-A in FIG. 2, in accordance with various embodiments.

FIG. 4 illustrates an example perspective view of a chassis containing two batteries, in accordance with various embodiments.

FIG. 5 illustrates an example view of an electrically driven vehicle with a battery extended out of the chassis cavity, in accordance with various embodiments.

### DETAILED DESCRIPTION OF THE INVENTION

Embodiments described in the present disclosure overcome at least some of the above-mentioned shortcomings and deficiencies by providing efficient ways for housing batteries in electrically driven vehicles. In particular, a vehicle chassis is described comprising an integrated internal cavity for holding one or more batteries. The batteries can be mounted within the chassis cavity in different ways. For example, a battery can be supported in the cavity on one or more rails, allowing the battery to slide or extend out of the chassis cavity on the rails for servicing and removal/replacement. In various embodiments, the chassis cavity can be separated into sub-compartments by one or more partition walls running inside the cavity. In this case, the vehicle can utilize multiple separate batteries, and the separate batteries can be held in different sub-compartments of the cavity. Similarly, each separate battery can be supported in the corresponding sub-compartment in different ways. For example, a separate battery can be supported in a sub-compartment on one or more rails, allowing the battery to slide or extend out of the sub-compartment on the rails for servicing and removal/replacement. Such a partition wall can be a structural part of the chassis, providing additional strength and rigidity to the chassis.

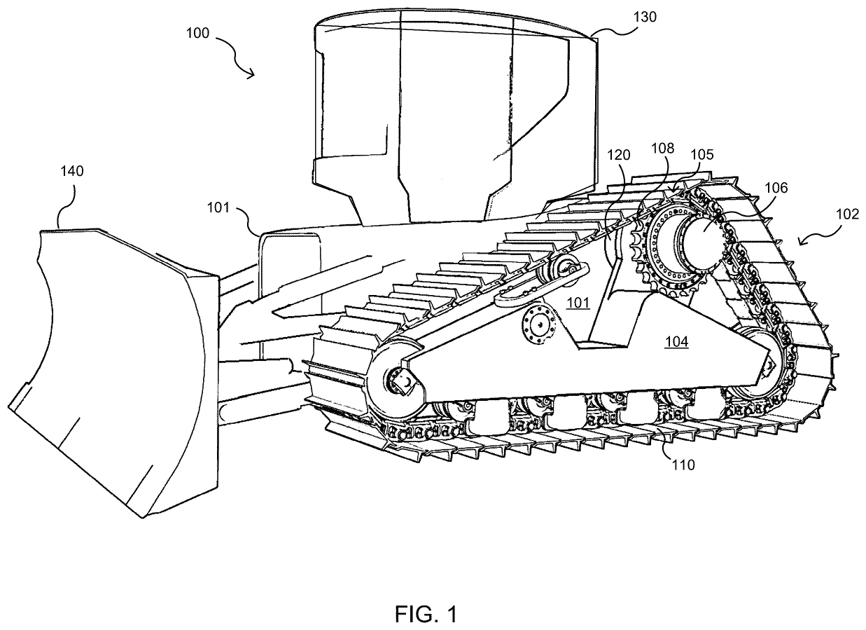

FIG. 1 illustrates an example of an electrically driven vehicle, in accordance with various embodiments. As illustrated in the example of FIG. 1, the vehicle 100, which in this case can be a bulldozer, includes a chassis 101 that is supported on the ground by a track assembly 102 attached to the side of the chassis 110. Although not illustrated in the example of FIG. 1, it is understood that a complementary track assembly with analogous components is supported on the other side of the chassis 101 and all applicable descriptions relating to the illustrated track assembly 102 can likewise apply to the complementary track assembly.

Each track assembly 102 includes a track frame 104 and a continuous track 110 that rotates about the track frame 104. An electrical motor 120 drives the continuous track 110 via a sprocket 108 held by a final drive 106 to propel the vehicle 100. One or more batteries (not illustrated) provide electrical power to the motor 120 via electrical connections for driving the vehicle. Power from the battery is selectively (e.g., under an operator's control) delivered to the motor 120 via a control system to provide control of the vehicle's 100 locomotion. As will be described in greater detail below, in various embodiments, the battery can be housed within the chassis 101.

In various embodiments, the chassis 101 serves as the main supporting structure of the vehicle 100. The chassis 101 can support various components of the vehicle, such as a cabin 130, a blade attachment 140 (a plate that is attached to the front of the bulldozer and used to dig and push through materials), a ripper (not illustrated), the continuous tracks 110, motors 120, batteries, and so on. As will be apparent to those skilled in the art, the vehicle 100 can be configurable to work with different attachments. For example, a different front attachment than a blade 140 can be used in the front and a different rear attachment than a ripper can be used in the rear.

The bulldozer-type vehicle illustrated in the example of FIG. 1 is just one example of an electrically driven vehicle for utilizing in-chassis batteries as described herein. In other embodiments, the electrically driven vehicle may be any other type of vehicle or machine containing a battery, such as a truck, tractor, loader, excavator, bus, car, dump truck, tank, and so on. Such electrically driven vehicles may be tracked vehicles using continuous tracks to move, such as the vehicle 100 of example 1. In various embodiments, the electrically driven vehicle may be a wheeled vehicle, using one or more wheels to move. In this case, one or more wheels of the vehicle can be powered by an electrical motor to which power is delivered from the battery or batteries held in the chassis.

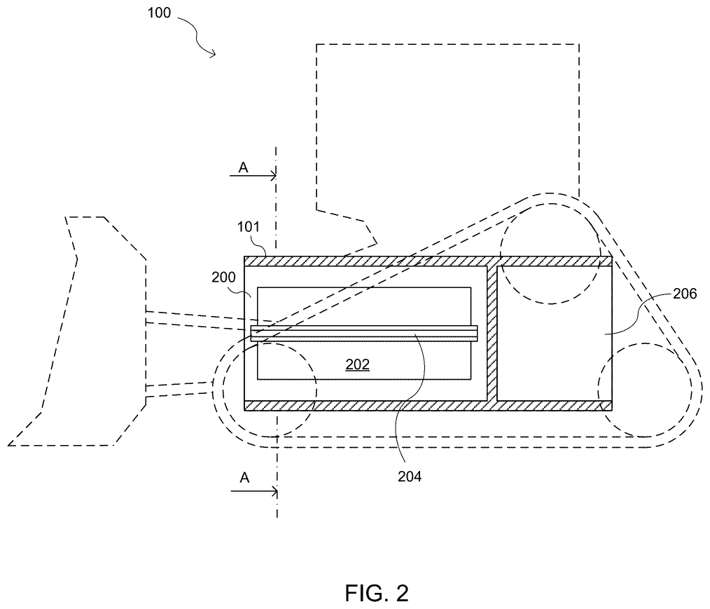

FIG. 2 illustrates an example cut away view of a chassis in an electrically driven vehicle, in accordance with various embodiments. A cross section of the chassis 101 is displayed in the example of FIG. 2. As illustrated, the chassis 101 defines a cavity 200. One or more batteries 202 is contained within the cavity 200. In various embodiments, the battery 202 is supported within the cavity 200 on one or more rails 204 (rails 204 can support the battery 202 from either side of the battery 202). In other embodiments, the battery 202 can be supported by rails from top and/or bottom. The rail 204 can be fastened to the chassis 101 and the battery can be mounted to the rail 204 such that the battery 202 can slide partially or fully out of the cavity 200 while supported on the rail 204, allowing for easier servicing or replacement of the battery 202 and related components that may be accessible through the cavity 200. In various embodiments, to enable the battery 202 to fully slide out of the cavity 200, telescoping rails can be used.

As will be described in further detail below, the cavity 200 can contain two or more batteries, which can be positioned side-by-side and separated by a partition wall. Each battery can similarly be supported on rails allowing the battery to slide out of the cavity 200 for servicing and replacement.

The cavity 200 is encased by structural portions of the chassis 101 on top, bottom, and sides to protect the battery 202 and provide structural strength to the chassis 101. The cavity 200 has an opening towards the front of the vehicle 100, through which the battery 202 can slide out and be accessed.

The chassis 101 further defines a second cavity 206 located towards the rear of the vehicle, which can house various other components and equipment of the vehicle 100, such as pumps, motors, computer modules, cooling systems, control units, air conditioning units, hydraulics, etc. The second cavity 206 is likewise encased on top, bottom, and sides.

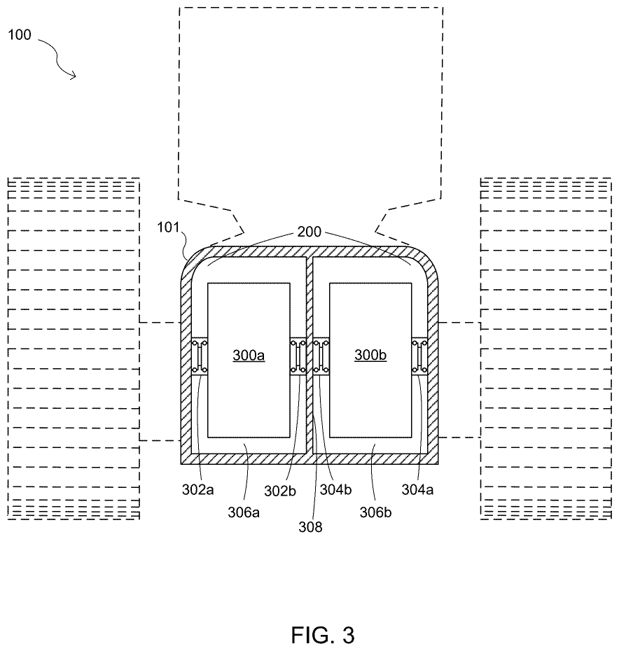

FIG. 3 illustrates a sectional view of the chassis as viewed from a line A-A in FIG. 2, in accordance with various embodiments. This figure illustrates a cross section of the chassis 101 along the line A-A in FIG. 2 and components held within the cavity, including two batteries 300a, 300b that are supported on sliding rails 302a, 302b, 304a, 304b.

As illustrated, the cavity 200 is divided into two sub-compartments 306a, 306b by a partition wall 308. Each sub compartment 306a, 306b holds a battery 300a, 300b on corresponding rails 302a, 302b, 304a, 304b, allowing each battery 300a, 300b to slide out of the chassis 101 while supported on the rails 302a, 302b, 304a, 304b. Each battery 300a, 300b is supported by a rail on either side, where one rail 302a, 304a is fastened to the wall of the corresponding sub-compartment 306a, 306b and the other rail 302b, 304b is fastened to the partition wall 308.

In this example, the partition wall 308 is vertically oriented and runs lengthwise inside the cavity 200, substantially along the middle of the cavity 200. The partition wall 308 can span the entire length of the cavity 200 or a portion of it. In various embodiment, the partition wall 308 is structural and ads strength and rigidity to the chassis 101.

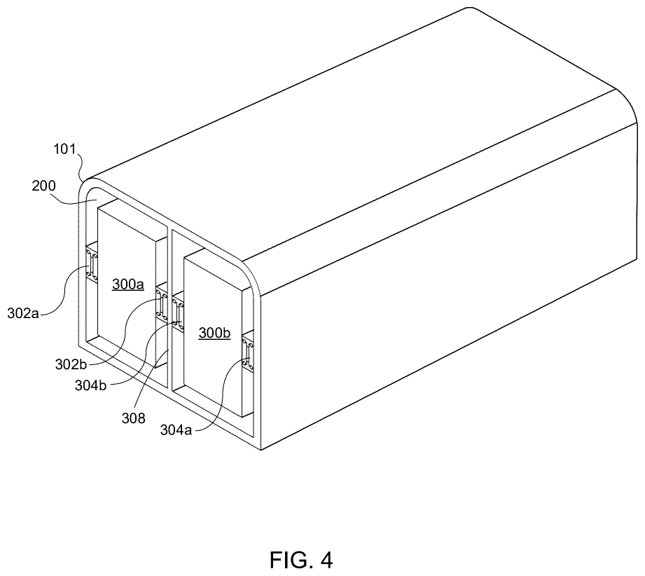

FIG. 4 illustrates an example perspective view of a chassis containing two batteries, in accordance with various embodiments. As illustrated in the example of FIG. 4 and the examples above, the chassis 101 comprises a structure formed around the interior cavity 200, in which cavity 200 the batteries 300a, 300b are held on respective rails 302a, 302b, 304a, 304b allowing the batteries 300a, 300b to slide and extend out towards the front of the vehicle 100 through the opening of the cavity 200. The structure of the chassis 101 encases the cavity 200 along the top, bottom, and sides, providing a protected structural enclosure or shell in which the batteries 300a, 300b are contained and leaving an opening in the cavity 200 towards the front of the chassis 101 for access.

Numerous advantages are achieved by arranging structural portions of the chassis 101 in this way. For example, this approach provides an exceptionally rigid and efficient structure in terms of material consumption and weight. Further, by encasing the battery in the structure of the chassis 101, the batteries are afforded protection (e.g., from impact), and the batteries are located low on the vehicle and out of the way of other components.

In various embodiments, the chassis 101 further comprises a partition wall 308 separating the cavity 200 into two sub-compartments for housing the batteries 300a, 300b. The partition wall 308 is oriented vertically along the length of the chassis 101 and runs through the cavity 200 (either the entire length of the cavity or a part of it). The partition wall 308 connects the top and bottom structural surfaces of the chassis 101, providing additional reinforcement. In various embodiments, the partitioning wall 308 is an integral structural component of the chassis, providing added rigidity and strength. For example, without such a partitioning wall 308, the top and bottom surfaces of the chassis 101 would need to cover a wider span without support, which would make these portions of the chassis more prone to failure under load or from impact. By placing a partition wall 308 in the cavity 200, the chassis 101 is strengthened. Further, using two smaller batteries as illustrated instead of, for example, one large battery, can have numerous advantages. For example, smaller batteries can be easier to cool, mount, replace, and service.

As will be appreciated by those skilled in the art, the illustrated chassis 101 in the example of FIG. 4 is a simplified representation of a chassis that would be implemented in a real-world application, which would generally contain various features such as openings, cutouts, reinforcements, attachment points, and so on. These features are not illustrated so as not to obscure the salient features of the invention. Furthermore, while the example of FIG. 4 and other examples provided herein illustrate the chassis 101 as being formed of continuous sheets of material; in other embodiments, the top, bottom, or sides of the chassis 101 as well as the partition wall 308 may have numerous cutouts (e.g., to preserve weight and material) or be formed entirely or partially of various connected structural members or braces, which may be preferrable for a particular implementation.

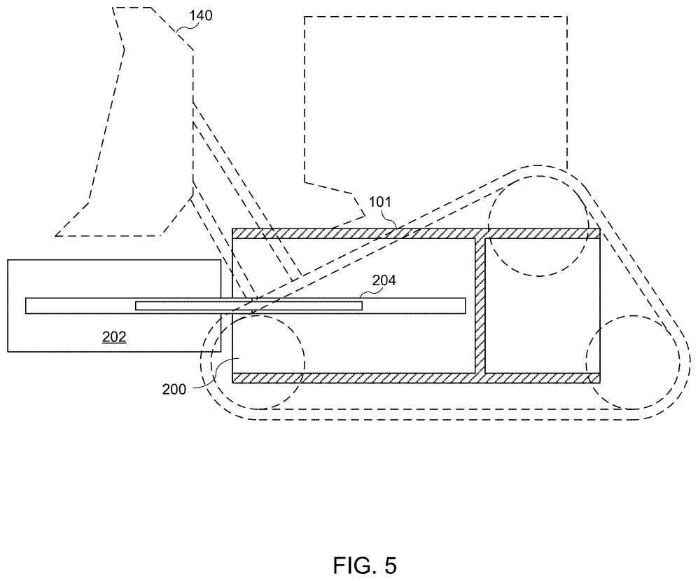

FIG. 5 illustrates an example view of an electrically driven vehicle with a battery extended out of the chassis cavity, in accordance with various embodiments. As illustrated in the example of FIG. 5, the battery 202 is extended out of the chassis cavity 200 on the rails 204, allowing for easier servicing and replacement of the battery 202. In embodiments where multiple batteries are housed in the chassis 101 as described above, each battery can be extended out of the chassis 101 independently for servicing.

In embodiments where the vehicle exhibits a blade 140 or other attachment at the front, such as the illustrated bulldozer, the blade position controlling mechanism, which is generally used to control the position of the blade 140 during vehicle operation, can be configured to elevate the blade (or whichever front attachment may be used at the time) up sufficiently to provide clearance for the battery 202 to be extended out from the front of the chassis 101. For example, when access to the battery is desired, the operator can lift the blade 140 to a “battery service” height, which can be a pre-configured setting in the blade position controls. Once the blade 140 is out of the way, the battery may be accessed (e.g., after opening a hatch or a door that seals off the battery compartment or cavity).

In other embodiments, the chassis can be configured for the battery to extend out on rails towards the rear of the vehicle. In this case, the battery cavity can be located towards the rear of the chassis and the second cavity (if there is one) can be positioned towards the front of the vehicle.

In various embodiments, the partitioning wall in the cavity can be oriented horizontally. In this case, for example, a partitioning wall can connect the right side of the chassis with the left side, creating sub-compartments on top of each other. Separate batteries can then be housed in the separate sub-compartments on top of each other instead of side by side as in the examples illustrated above.

In various embodiments, the battery or batteries can be mounted in the chassis cavity or in a sub-compartment without using sliding rails. For example, removable fasteners (e.g., bolts) can be used to directly mount the batteries in the cavity or a sub-compartment so that the batteries can be removed or replaced for servicing.

In various embodiments, the cavity 200 can be configured without the partitioning wall 308. For example, the cavity 200 can define one undivided compartment for containing the battery or batteries of the vehicle. In this case, a single battery or multiple batteries can be contained in the cavity 200. The battery or batteries can be mounted to the interior cavity walls (e.g., using fasteners). In some embodiments, the battery or batteries can be supported in the cavity on rails as described above, so that the battery or batteries can slide out of the cavity towards the front or rear of the vehicle while supported on the rails.

It should be understood that identical element symbols used on multiple figures refer to the same component, or components of equal functionality. Additionally, the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the invention which is set forth in the following claims.

1. An electrically driven vehicle, comprising:
a chassis;
at least one track or wheel for supporting the chassis and propelling the electrically driven vehicle;
an electric motor for powering the at least one track or wheel;
a cavity in the chassis housing a battery that supplies power to the electric motor, the cavity being encased by structural portions of the chassis on top, bottom, and sides of the cavity, wherein the cavity comprises an opening towards the front or the rear of the vehicle for accessing the battery.

2. The electrically driven vehicle of claim 1, further comprising:
a rail supporting the battery within the cavity, wherein the rail is operable to slide the battery out of the cavity opening while supporting the battery.

3. The electrically driven vehicle of claim 1, further comprising a second battery housed in the cavity.

4. The electrically driven vehicle of claim 2, further comprising:
a second rail supporting a second battery within the cavity, wherein the second rail is operable to slide the second battery out of the cavity opening while supporting the second battery.

5. The electrically driven vehicle of claim 3, further comprising a vertical partition wall separating the cavity into a first sub-compartment for housing the first battery and a second sub-compartment for housing the second battery.

6. The electrically driven vehicle of claim 5, further comprising:
the first rail supporting the first battery within the first sub-compartment, wherein the first rail is operable to slide the battery out of the cavity opening while supporting the first battery; and
the second rail supporting the second battery within the second sub-compartment, wherein the second rail is operable to slide the second battery out of the cavity opening while supporting the second battery.

7. The electrically driven vehicle of claim 6, wherein the first rail and the second rail are mounted to the partition wall.

8. The electrically driven vehicle of claim 7, further comprising:
a third rail supporting the first battery within the first sub-compartment, wherein the third rail is operable to slide the first battery out of the cavity opening while supporting the first battery, and wherein the third rail is mounted to a wall of the cavity; and
a fourth rail supporting the second battery within the second sub-compartment, wherein the fourth rail is operable to slide the second battery out of the cavity opening while supporting the second battery, and wherein the fourth rail is mounted to a wall of the cavity.

9. The electrically driven vehicle of claim 3, further comprising a horizontal partition wall separating the cavity into a first sub-compartment for housing the first battery and a second sub-compartment for housing the second battery.

10. The electrically driven vehicle of claim 2, wherein the cavity comprises an opening towards the front of the vehicle for accessing the battery, further comprising:
a front attachment at the front of the vehicle, wherein the vehicle is operable to raise the front attachment to a battery service height providing sufficient clearance to slide the battery out of the cavity opening.

11. A chassis for providing primary structural support in an electrically driven vehicle, the electrically driven vehicle being propelled by at least one track or wheel powered by an electric motor receiving power from a battery, the chassis comprising:
a cavity in the chassis for housing the battery, the cavity being encased by structural portions of the chassis on top, bottom, and sides of the cavity, wherein the cavity comprises an opening towards the front or the rear of the vehicle for accessing the battery.

12. The chassis of claim 11, further comprising:
a rail supporting the battery within the cavity, wherein the rail is operable to slide the battery out of the cavity opening while supporting the battery.

13. The chassis of claim 11, further comprising a second battery housed in the cavity.

14. The chassis of claim 12, further comprising:
a second rail supporting a second battery within the cavity, wherein the second rail is operable to slide the second battery out of the cavity opening while supporting the second battery.

15. The chassis of claim 13, further comprising a vertical partition wall separating the cavity into a first sub-compartment for housing the first battery and a second sub-compartment for housing the second battery.

16. The chassis of claim 15, further comprising:
the first rail supporting the first battery within the first sub-compartment, wherein the first rail is operable to slide the battery out of the cavity opening while supporting the first battery; and
the second rail supporting the second battery within the second sub-compartment, wherein the second rail is operable to slide the second battery out of the cavity opening while supporting the second battery.

17. The chassis of claim 16, wherein the first rail and the second rail are mounted to the partition wall.

18. The chassis of claim 17, further comprising:
a third rail supporting the first battery within the first sub-compartment, wherein the third rail is operable to slide the first battery out of the cavity opening while supporting the first battery, and wherein the third rail is mounted to a wall of the cavity; and
a fourth rail supporting the second battery within the second sub-compartment, wherein the fourth rail is operable to slide the second battery out of the cavity opening while supporting the second battery, and wherein the fourth rail is mounted to a wall of the cavity.

19. The chassis of claim 13, further comprising a horizontal partition wall separating the cavity into a first sub-compartment for housing the first battery and a second sub-compartment for housing the second battery.
